(19) United States
(12) Patent Application Publication
(10) Pub. No.: US 2012/0330545 A1
(43) Pub. Date: Dec. 27, 2012

(54) MOBILE TERMINAL DEVICE, VELOCITY CALCULATION METHOD, AND COMPUTER-READABLE RECORDING MEDIUM STORING VELOCITY CALCULATION PROGRAM

(75) Inventor: Shinjiro Suzuki, Kawasaki (JP)

(73) Assignee: FUJITSU LIMITED, Kawasaki-shi (JP)

(21) Appl. No.: 13/524,126

(22) Filed: Jun. 15, 2012

(30) Foreign Application Priority Data
Jun. 27, 2011 (JP) 2011-142233

(51) Int. Cl. G01C 21/12

(52) U.S. Cl. 701/472

(57) ABSTRACT

A mobile terminal device includes an acquisition unit configured to acquire a velocity based on GPS information; a first calculation unit configured to calculate a correlation coefficient and a correlation value between an acceleration obtained from the velocity and data of an acceleration sensor; a second calculation unit configured to calculate, using the correlation coefficient, the correlation value, and the data of the acceleration sensor, an acceleration in a section in which it is hard to receive the GPS information; and a third calculation unit configured to calculate a velocity in the section using the acceleration calculated by the second calculation unit and velocities acquired before and after the section.

### CROSS-REFERENCE TO RELATED APPLICATION

This application is based upon and claims the benefit of priority of the prior Japanese Patent Application No. 2011-142233, filed on Jun. 27, 2011, the entire contents of which are incorporated herein by reference.

### FIELD

Embodiments disclosed herein are related to a mobile terminal device that calculates a vehicle velocity in a section in which it is hard to receive GPS information, a velocity calculation method, and a computer-readable recording medium storing therein a velocity calculation program.

### BACKGROUND

In recent years, mobile terminal devices compatible with a Global Positioning System (GPS) may be capable of measuring the velocities of mobile terminal devices using GPS receivers. However, it may be hard to measure the velocity of a mobile terminal device in a section in which it is hard to receive a radio wave from a GPS satellite. On the other hand, there has been a technique that autonomously estimates a current location in a section in which it is hard to acquire GPS information.

In addition, in each of Japanese Laid-open Patent Publication No. 2011-64501, Japanese Laid-open Patent Publication No. 11-295103, and Japanese Laid-open Patent Publication No. 2005-17308, there is disclosed a technique that estimates a current location or calculates a velocity using the data of an acceleration sensor without using the GPS information. In addition, in Japanese Laid-open Patent Publication No. 2008-76389, there is disclosed a technique that estimates the location, the velocity, and the attitude of a vehicle using a navigation system based on INS/GPS, in which a method for determining the location, the velocity, and the attitude of a vehicle on the basis of an inertial navigation system (INS) and GPS are combined.

Here, recently, adequate velocity data (hereinafter, referred to as an ideal velocity curve) has been formed from the velocity data of a vehicle, and an economical drive index value has been calculated by integrating a difference between an actual velocity and the ideal velocity curve. In addition, there has been considered guiding a driver for economical drive using the economical drive index value. An example of the ideal velocity curve is disclosed in Japanese Patent No. 3944549.

In a system in which economical drive guidance is performed, while there is a function for accumulating the velocity of a vehicle, it is the case that the velocity data is obtained by attaching an in-vehicle terminal to the vehicle. Since the in-vehicle terminal is an expensive measurement device, it is hard to promote the attachment of the in-vehicle terminal to a general passenger vehicle.

On the other hand, since it is possible to calculate a moving velocity or a current location using a mobile terminal device with a GPS function, there may be considered utilizing and applying velocity data due to the mobile terminal device to the present system.

However, in a section such as a tunnel or the like (hereinafter, referred to as an unreceiving section), in which it is hard to acquire the GPS information, it is hard to calculate a velocity due to GPS information (hereinafter, referred to as a GPS velocity). In the unreceiving section, while it may be possible to calculate an average velocity from a time at which the mobile terminal device has entered into the section and a time at which the mobile terminal device has gone out of the section, it is hard to understand the details of acceleration and deceleration.

In place of the GPS velocity, there may also be considered acquiring location information from an acceleration sensor and an angular velocity sensor and calculating a velocity from the location information and time information, in the same way as in a technique of the related art. In order to do this, it is desirable to provide the acceleration sensor and the angular velocity sensor, and hence a cost increases. In mobile terminal devices of recent years, while mobile terminal devices equipped with acceleration sensors exist, a few mobile terminal devices equipped with angular velocity sensors exist.

In addition, since the velocity of a vehicle, which has been calculated only using an acceleration sensor in the same way as in a technique of the related art, may be influenced by the vibration of the acceleration sensor owing to the influence of a road surface or the like, in addition to the acceleration and the deceleration of the vehicle itself equipped with the acceleration sensor, it is hard to obtain a high degree of accuracy.

### SUMMARY

In accordance with an aspect of the embodiments, a mobile terminal device includes an acquisition unit configured to acquire a velocity based on GPS information; a first calculation unit configured to calculate a correlation coefficient and a correlation value between an acceleration obtained from the velocity and data of an acceleration sensor; a second calculation unit configured to calculate, using the correlation coefficient, the correlation value, and the data of the acceleration sensor, an acceleration in a section in which it is hard to receive the GPS information; and a third calculation unit configured to calculate a velocity in the section using the acceleration calculated by the second calculation unit and velocities acquired before and after the section.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a scatter diagram based on GPS acceleration and acceleration of an X-axis acceleration sensor;

FIG. 2 is a scatter diagram based on GPS acceleration and acceleration of a Y-axis acceleration sensor;

FIG. 3 is a scatter diagram based on GPS acceleration and acceleration of a Z-axis acceleration sensor;

FIG. 4 is a diagram illustrating a change in a correlation coefficient with respect to each specific quantity of data;

FIG. 5 is a scatter diagram based on GPS acceleration and an output value of an acceleration sensor in a section in which a correlation coefficient is large;

FIG. 6 is a scatter diagram based on GPS acceleration and an output value of an acceleration sensor in a section in which a correlation coefficient is small;

FIG. 7 is a block diagram illustrating an example of a configuration of a mobile terminal device in a first embodiment;

FIG. 8 is a block diagram illustrating an example of a configuration of a velocity calculation unit in the first embodiment;

FIG. 9 is a diagram illustrating an example of a relationship between a velocity per hour and a velocity per second;

FIG. 10 is a diagram illustrating an example of a variation width of kinetic energy with respect to a velocity;

FIG. 11 is a diagram illustrating an example of a variable amount (acceleration) of a velocity component with respect to a velocity;

FIG. 12 is a diagram illustrating an example of a value obtained by combining a velocity calculated from an entrance and a velocity calculated from an exit;

FIG. 13 is a diagram illustrating an example of GPS information from a GPS satellite;

FIG. 14 is a diagram illustrating an example of sensor information;

FIG. 15 is a diagram illustrating an example of location information;

FIG. 16 is a diagram illustrating an example of a parameter;

FIG. 17 is a diagram illustrating an example of information relating to an upper limit value and a lower limit of acceleration;

FIG. 18 is a flowchart illustrating an example of measurement start processing for a velocity in the first embodiment;

FIG. 19 is a flowchart illustrating an example of acquisition processing for each piece of data in a triaxial acceleration sensor in the first embodiment;

FIG. 20 is a flowchart illustrating an example of acquisition processing for GPS information in a GPS processor in the first embodiment;

FIGS. 21A and 21B are flowcharts illustrating an example of velocity measurement processing in the first embodiment;

FIG. 22 is a diagram illustrating an example of initializing processing for synchronizing GPS information and sensor information with each other;

FIG. 23 is a diagram illustrating an example of processing performed when a software timer interrupt normally occurs;

FIG. 24 is a diagram illustrating an example of processing performed when a software timer interrupt is omitted;

FIG. 25 is a diagram illustrating an example of a processing procedure of measurement information;

FIG. 26 is a block diagram illustrating an example of a configuration of a mobile terminal device in a second embodiment;

FIG. 27 is a block diagram illustrating an example of a configuration of a velocity calculation unit in the second embodiment;

FIG. 28 is a diagram illustrating a change in a direction of the earth's axis due to a change in a road gradient within an unreceiving section;

FIG. 29 is a diagram illustrating an example of a velocity calculated within an unreceiving section using a triaxial acceleration sensor;

FIG. 30 is a diagram illustrating an example of a change in an atmospheric pressure due to a change in a gradient;

FIG. 31 is a flowchart illustrating an example of measurement start processing for a velocity in the second embodiment;

FIG. 32 is a flowchart illustrating an example of acquisition processing for each piece of data in each sensor in the second embodiment;

FIGS. 33A and 33B are flowcharts illustrating an example of velocity measurement processing in the second embodiment; and

FIG. 34 is a diagram illustrating an example of a configuration of a mobile terminal device.

### DESCRIPTION OF EMBODIMENTS

First, a correlation between GPS acceleration and each piece of data of a triaxial acceleration sensor will be described. As for the GPS acceleration, it is possible to convert a GPS velocity into acceleration by calculating a difference between the GPS velocity and the GPS velocity of one second ago. The GPS velocity may be included in GPS information received from a GPS satellite, or may be calculated from the location information and the time information of the GPS information.

The inventors found out that a first order correlative relationship occurs between the calculated GPS acceleration and the output value (each piece of data) of each axis of the triaxial acceleration sensor. A correlative relationship is evaluated only when a velocity is other than “0”. This is because the correlation coefficient is avoided from becoming small while a vehicle is in park when the velocity “0” is an evaluation target.

Since there is the correlative relationship between the GPS acceleration and each piece of data of the triaxial acceleration sensor, the following Expression is satisfied.

Y=aX×gX+bX Expression (1)

Y=aY×gY+bY Expression (2)

Y=aZ×gZ+bZ Expression (3)
Y: GPS acceleration

aX, aY, and aZ: correlation coefficients with respect to accelerations output from the individual axes of the triaxial acceleration sensor

gX, gY, and gZ: accelerations output from the individual axes of the triaxial acceleration sensor

bX, bY, and bZ: correlation values with respect to accelerations output from the individual axes of the triaxial acceleration sensor

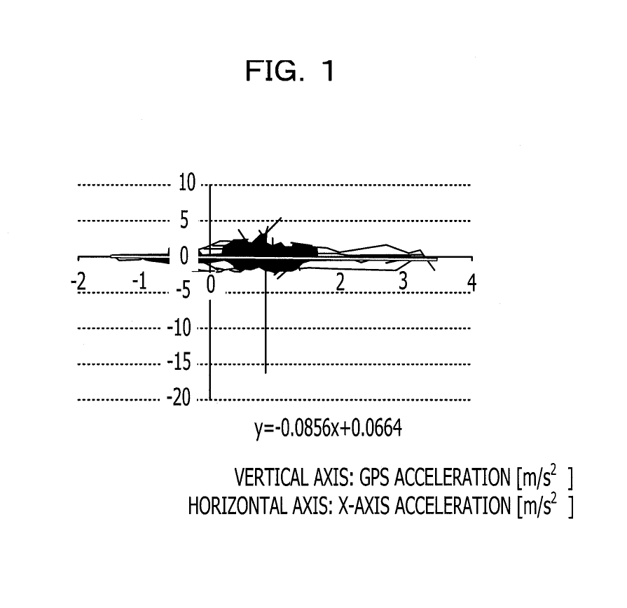

Here, FIGS. 1 to 3 illustrate scatter diagrams based on accelerations calculated from GPS velocities in the operation of a vehicle and accelerations acquired by the individual pieces of data of the acceleration sensor. This experiment illustrates a case in which measurement is performed with a mobile phone terminal with a GPS function being fixed to a holder at the air outlet of the air conditioner of the vehicle. In addition, FIGS. 1 to 3 are scatter diagrams of data acquired from the start of the operation of the vehicle to the end thereof.

FIG. 1 is a scatter diagram based on the GPS acceleration and the acceleration of an X-axis acceleration sensor. As illustrated in FIG. 1, as for a correlative relationship with an X-axis, a correlation coefficient is “−0.0856”, and a correlation value is “0.0664”.

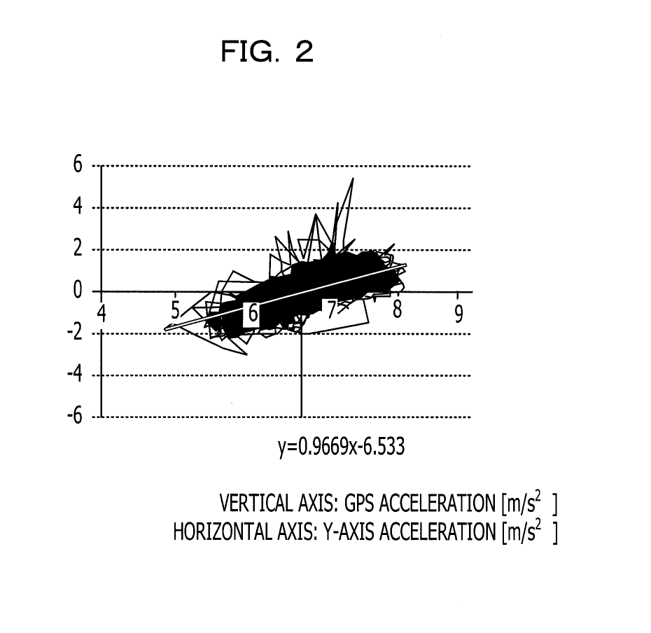

FIG. 2 is a scatter diagram based on the GPS acceleration and the acceleration of a Y-axis acceleration sensor. As illustrated in FIG. 2, as for a correlative relationship with a Y-axis, a correlation coefficient is “0.9669”, and a correlation value is “6.533”.

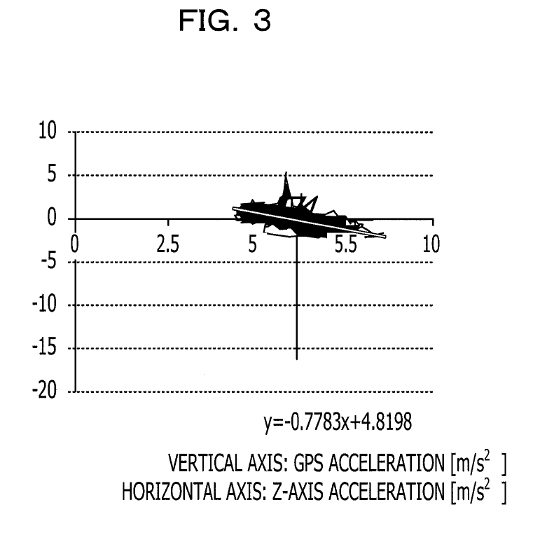

FIG. 3 is a scatter diagram based on the GPS acceleration and the acceleration of a Z-axis acceleration sensor. As illustrated in FIG. 3, as for a correlative relationship with a Z-axis, a correlation coefficient is “−0.7783”, and a correlation value is “4.8198”.

From results illustrated in FIGS. 1 to 3, it may be understood that correlative relationships occur between the acceleration of the vehicle, measured by the mobile phone terminal with a GPS function, and two axes of the triaxial acceleration sensor. This is because two axes where the absolute values of the correlation coefficients are large are selected. In addition, while an example will be described in which the triaxial acceleration sensor is used, a plurality of single-axis acceleration sensors may be combined and a plurality of acceleration sensors where the absolute values of correlation coefficients are large may be used. In the examples illustrated in FIGS. 1 to 3, the GPS acceleration has correlative relationships with the output values of the Y-axis and the Z-axis. The output value of the X-axis is an output value that does not influence the GPS acceleration.

If the mobile terminal device continuously has a same attitude during a time period for acquiring data due to the mobile terminal device, the correlation coefficient and the correlation value may be evaluated on the basis of all pieces of data from the operation start to the operation end.

However, actually the attitude of the mobile terminal device changes owing to the undulation of a road or an operation such as holding the mobile terminal device or the like in one hand. In order to evaluate the correlation coefficient and the correlation value with respect to such an attitude change in the mobile terminal device, a value may be regularly updated on the basis of a specific quantity of data. By regularly updating the sample data, a difference occurs in the degree of variability in acquired samples, and as a result, the values of the correlation coefficient and the correlation value also change.

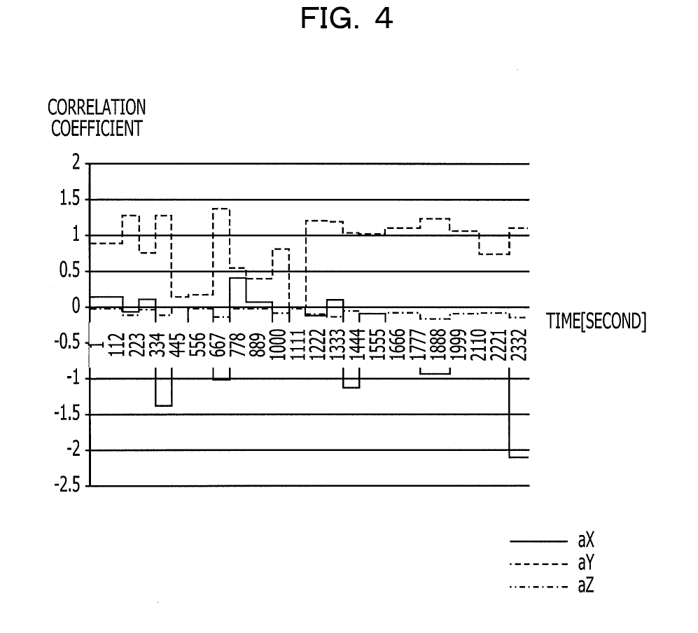

FIG. 4 is a diagram illustrating a change in a correlation coefficient with respect to each specific quantity of data. In the example illustrated in FIG. 4, the correlation coefficient becomes large in a section in which acceleration and deceleration such as the stop and running of the vehicle frequently occur, and the correlation coefficient becomes small in a section in which the vehicle runs with a fixed velocity.

This variation of the correlation coefficient is influenced by “a mountain area where the undulation of a road is large”, “an urban area where acceleration and deceleration frequently occur”, “a toll road where fixed velocity drive prevails”, and “the fixed velocity driving capability of a driver”. Any one of those is a problem dependent on a specific section or the driving characteristic of a driver, and may be determined as a phenomenon that it is hard for a change to immediately occur when a radio wave from the GPS satellite has not been acquired.

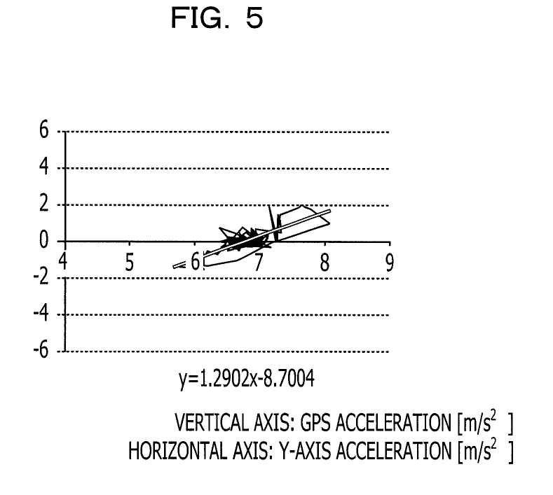

FIG. 5 is a scatter diagram based on the GPS acceleration and the output value of an acceleration sensor in a section in which the correlation coefficient is large. In the example illustrated in FIG. 5, the acceleration of the Y-axis is used. A section in which the correlation coefficient is large corresponds to a section such as “a mountain area where the undulation of a road is large”, “an urban area where acceleration and deceleration frequently occur”, or the like, for example.

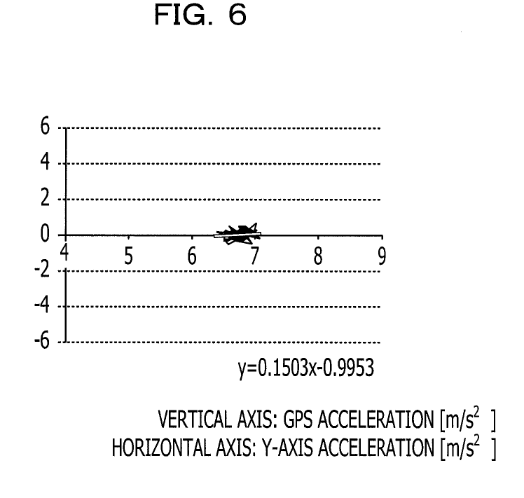

FIG. 6 is a scatter diagram based on the GPS acceleration and the output value of the acceleration sensor in a section in which the correlation coefficient is small. In the example illustrated in FIG. 6, the acceleration of the Y-axis is used. A section in which the correlation coefficient is small corresponds to a section such as “a toll road where fixed velocity drive prevails”, or the like, for example.

As illustrated in FIG. 5 or FIG. 6, since the correlation coefficient fluctuates, this value is regularly updated. In addition, the GPS acceleration may be calculated from this correlation coefficient, this correlation value, and the output value of the acceleration sensor. Accordingly, in a section (also referred to as an unreceiving section) in which it is hard to acquire the GPS information, the GPS acceleration is calculated using the correlation coefficient and the correlation value, calculated in a section (also referred to as a receivable section) in which it has been possible to receive the GPS information, and the output value of the acceleration sensor in the unreceiving section. In addition, using the calculated GPS acceleration and the GPS velocities acquired before and after the unreceiving section, a velocity in the unreceiving section may be calculated.

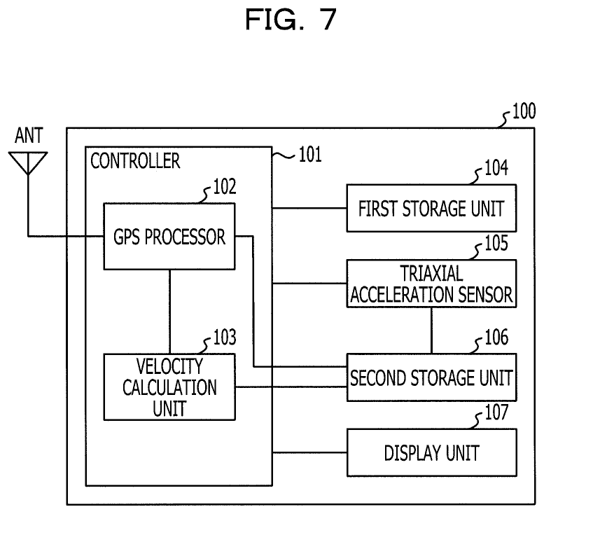

FIG. 7 is a block diagram illustrating an example of the configuration of a mobile terminal device 100 in a first embodiment. The mobile terminal device 100 includes an antenna (ANT), a controller 101, a first storage unit 104, a triaxial acceleration sensor 105, a second storage unit 106, and a display unit 107.

The antenna (ANT) receives a GPS signal from the GPS satellite, and outputs this GPS signal to a GPS processor 102 in the controller 101.

For example, the controller 101 is a central processor unit (CPU), and controls the processing of the mobile terminal device 100 on the basis of a basic program read out from the first storage unit 104. A velocity calculation program described later is included in the basic program.

For example, the first storage unit 104 is a nonvolatile memory or the like, and is a storage unit storing therein data relating to the basic program, an application software and the like.

The triaxial acceleration sensor 105 measures and stores the acceleration gX along the X-axis, the acceleration gY along the Y-axis, and the acceleration gZ along the Z-axis in the second storage unit 106.

For example, the second storage unit 106 is a volatile memory or the like, and is a storage unit storing or temporarily storing therein data or the like, generated by the basic program, the application software, or the like, executed by the controller 101.

The display unit 107 includes a liquid crystal display (LCD) or the like, and performs display in accordance with display data input from the controller 101.

In addition, when velocity calculation processing or the like is executed, the controller 101 includes the functions of a GPS processor 102 and a velocity calculation unit 103.

The GPS processor 102 demodulates the GPS signal acquired from the antenna, and acquires GPS information such as a satellite time, a latitude, a longitude, a velocity, and the like. The GPS processor 102 stores the acquired GPS information in the second storage unit 106. In addition, for example, the GPS processor 102 outputs a velocity (GPS velocity) to the velocity calculation unit 103.

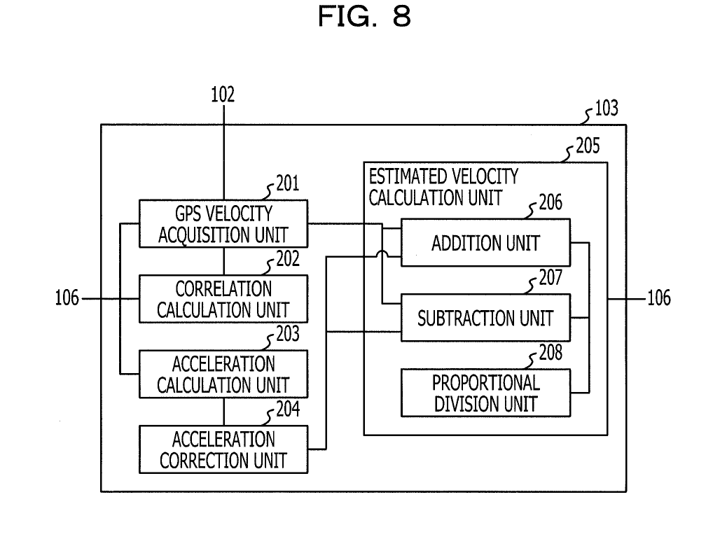

The velocity calculation unit 103 calculates a correlation coefficient and a correlation value between the GPS velocity acquired from the GPS processor 102 or the second storage unit 106 and each piece of data of the triaxial acceleration sensor 105, acquired from the second storage unit 106. In the unreceiving section in which it is hard to acquire the GPS information, the velocity calculation unit 103 calculates the velocity of the vehicle using this correlation coefficient and this correlation value. A function for calculating a velocity in the unreceiving section will be described using FIG. 8.

FIG. 8 is a block diagram illustrating an example of the configuration of the velocity calculation unit 103 in the first embodiment. The velocity calculation unit 103 illustrated in FIG. 8 includes the individual functions of a GPS velocity acquisition unit 201, a correlation calculation unit 202, an acceleration calculation unit 203, an acceleration correction unit 204, and an estimated velocity calculation unit 205.

The GPS velocity acquisition unit 201 acquires the GPS velocity from the GPS processor 102 or the second storage unit 106. The GPS velocity acquisition unit 201 outputs a GPS velocity in the receivable section to the correlation calculation unit 202. In addition, the GPS velocity acquisition unit 201 outputs GPS velocities before and after the unreceiving section, to the estimated velocity calculation unit 205.

The correlation calculation unit 202 calculates an GPS acceleration using the GPS velocity acquired from the GPS velocity acquisition unit 201. The GPS acceleration may be calculated on the basis of the variation of the GPS velocity per second. For example, using a least-square method or the like, the correlation calculation unit 202 calculates the correlation coefficient and the correlation value between this GPS acceleration and each piece of data of the triaxial acceleration sensor 105, acquired from the second storage unit 106. The correlation calculation unit 202 stores the calculated correlation coefficient and the calculated correlation value in the second storage unit 106.

The acceleration calculation unit 203 calculates the acceleration of the vehicle in the unreceiving section. The acceleration calculation unit 203 acquires, from the second storage unit 106, the correlation coefficient, the correlation value, and each piece of data of the triaxial acceleration sensor 105, weights the data of the triaxial acceleration sensor 105 with correlation coefficients, using two axes whose correlation coefficients are high, for example, and calculates an acceleration.

Acceleration=(acceleration of axis 1×absolute value of correlation coefficient of axis 1+acceleration of axis 2×absolute value of correlation coefficient of axis 2)/(absolute value of correlation coefficient of axis 1+absolute value of correlation coefficient of axis 2) Expression (4)

The acceleration calculation unit 203 outputs the calculated acceleration to the acceleration correction unit 204.

The acceleration correction unit 204 performs processing for removing unexpected data in the calculated acceleration. For example, the acceleration correction unit 204 performs processing for rounding the calculated acceleration to within a predetermined range. The unexpected data of the acceleration will be described.

For example, when a vehicle is running along an expressway, the vehicle reaches a velocity form which it is hard to accelerate even with fully pressing down on an accelerator, in some cases. It is assumed that this velocity is called the terminal velocity of the vehicle. In a vehicle such as a truck or the like, whose air resistance is large, the terminal velocity of the vehicle is notably felt.

As resistance added to the running vehicle, an engine, a transmission, the rolling resistance of a tire, and air resistance may be considered. Among these, the engine, the transmission, and the rolling resistance of a tire are fixed resistance not influenced by the velocity of the vehicle.

On the other hand, the air resistance is a resistance component whose resistance increases in a quadratic curve as a value obtained by multiplying an air resistance coefficient by the square of the velocity. By presuming the terminal velocity of the velocity, a surplus energy the vehicle has is estimated, and an acceleration variable range with respect to each velocity is identified and used for the prediction of the velocity.

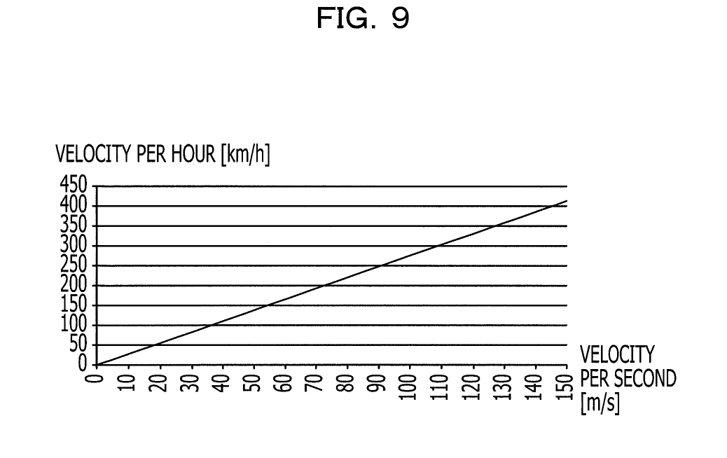

For ease of explanation, it is assumed that the velocity is not considered as a velocity per hour but as a velocity per second. FIG. 9 is a diagram illustrating an example of a relationship between a velocity per hour and a velocity per second.

Here, if it is assumed that the terminal velocity of the vehicle is 41 m/s (about 150 km/h), as for energy E generated by the engine, the following Expression is satisfied.

E−A*V²=0 Expression (5)
Terminal velocity: V=41
Air resistance: A=1

According to Expression (5), the energy E turns out to be “1681”.

As for the surplus energy at a predetermined velocity, the following Expression is satisfied.

f(v)=E−A*v² Expression (6)
f(v): Surplus energy

Against the energy generated by the engine, brakes are provided for the vehicle. Energy the brakes may absorb is dependent on a frictional force between tires and a road surface as long as the brakes maintain a state in which the brakes may fully release heat. Therefore, the energy the brakes may absorb with respect to a velocity is fixed.

When it is assumed that the capacity of brakes is one and half times as large as the capacity of the engine, the following Expression is satisfied from the value of the energy E of the engine.

B=E×1.5 Expression (7)
B≈2521

Here, when it is assumed that a ratio (power-to-weight ratio) between the increase of the kinetic energy of the vehicle and the energy generated by the engine is 1:10, the increase of the kinetic energy satisfies the following Expression.

F(v)=10×A*v² Expression (8)

Under the above-mentioned condition, with the width of variation in the kinetic energy with respect to the velocity being in a predetermined range, the acceleration correction unit 204 corrects the calculated acceleration so that the acceleration falls within a predetermined range.

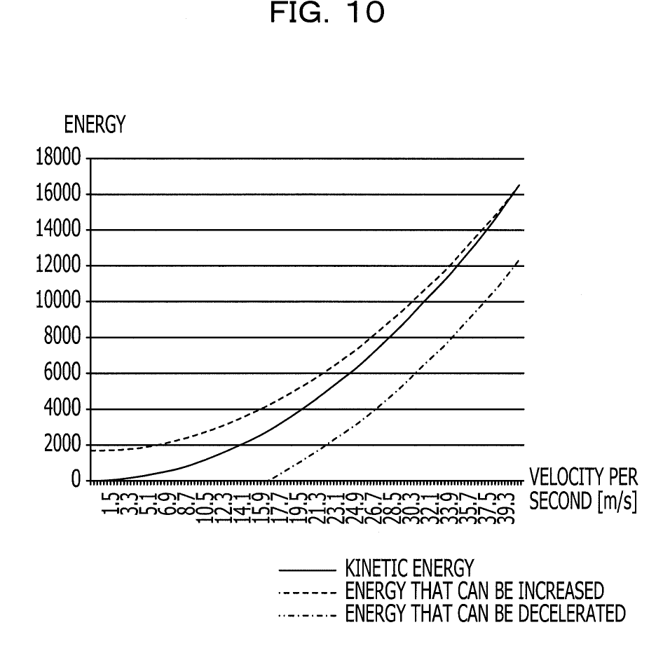

FIG. 10 is a diagram illustrating an example of the variation width of the kinetic energy with respect to the velocity. A solid line illustrated in FIG. 10 indicates the kinetic energy, a dotted line indicates energy that may be increased, and a dashed-dotted line indicates energy that may be decelerated.

The kinetic energy illustrated in FIG. 10 is F(v), the energy that may be increased is F(v)+f(v), and the energy that may be decelerated is F(v)−A*v²−B.

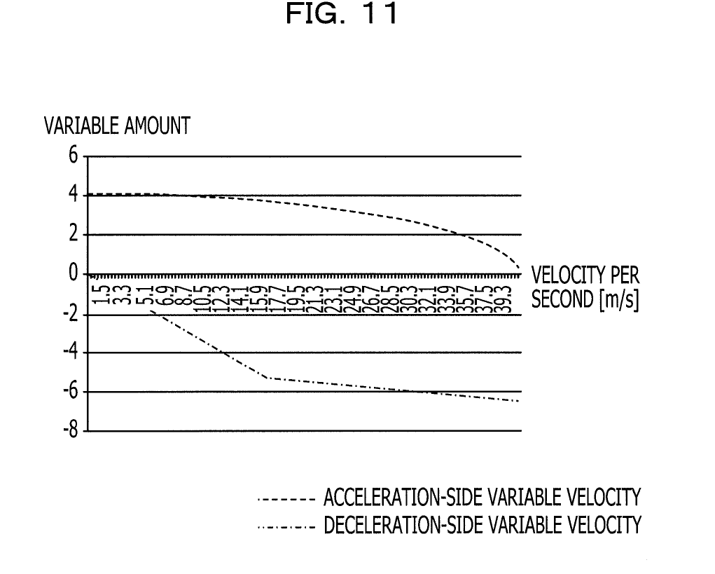

FIG. 11 is a diagram illustrating an example of the variable amount (acceleration) of a velocity component with respect to the velocity. As for the diagram illustrated in FIG. 11, the variable amount is calculated under the condition that the vehicle is not suddenly reversed from a state in which the vehicle moves forward.

As illustrated in FIG. 11, the variable amount of acceleration with respect to a predetermined velocity is determined. When the variable amount of acceleration with respect to a predetermined velocity has been determined, the acceleration correction unit 204 corrects the calculated acceleration so that the acceleration becomes the upper limit value of the variable amount if the calculated acceleration exceeds the upper limit value. In addition to this, the acceleration correction unit 204 corrects the calculated acceleration so that the acceleration becomes the lower limit value of the variable amount if the calculated acceleration falls below the lower limit value. For example, the predetermined velocity is a velocity immediately before the vehicle enters the unreceiving section or a velocity of predetermined seconds ago, calculated by the estimated velocity calculation unit 205.

The acceleration correction unit 204 may only hold the variable amount of the acceleration with respect to the velocity illustrated in FIG. 11. In addition, in response to the velocity, the acceleration correction unit 204 may also acquire the variable amount stored in the second storage unit 106, for example.

When the calculated acceleration falls within the range of the variable amount, the acceleration correction unit 204 does not perform correction. The acceleration correction unit 204 outputs the acceleration within the range of the variable amount to the estimated velocity calculation unit 205. Accordingly, by simulating the terminal velocity of the vehicle, it may be possible to set a fixed limit on a change in the velocity the vehicle may have in the next instant, namely, the acceleration. In addition, the function of the acceleration correction unit 204 may be omitted.

Returning to FIG. 8, the estimated velocity calculation unit 205 calculates and estimates the velocity of the vehicle in the unreceiving section in which it is hard to receive the GPS signal from the GPS satellite. The estimated velocity calculation unit 205 includes the individual functions of an addition unit 206, a subtraction unit 207, and a proportional division unit 208.

The addition unit 206 continues to add the acceleration acquired from the acceleration correction unit 204, to the GPS velocity acquired immediately before the unreceiving section. The velocity to which the acceleration has been added is output to the proportional division unit 208.

The subtraction unit 207 continues to subtract the acceleration acquired from the acceleration correction unit 204, temporally backward from the GPS velocity acquired immediately after the unreceiving section. The velocity from which the acceleration has been subtracted is output to the proportional division unit 208.

The proportional division unit 208 calculates a combined value obtained by proportionally dividing the rates of the velocity to which the acceleration has been added from the entrance of the unreceiving section and the velocity from which the acceleration has been subtracted from the exit thereof, on the basis of the number of the sections of the unreceiving section. The proportional division unit 208 regards this combined value as a velocity in the unreceiving section. An estimated velocity is a likely velocity calculated with respect to the unreceiving section.

For example, in a case in which a unit time (for example, one second) corresponds to one section, when the entire section of the unreceiving section corresponds to “t”, an unreceiving section at the time of the calculation of the velocity corresponds to “s”, the velocity subjected to addition at this time is v1(s), and the velocity subjected to subtraction at this time is v2(s), the proportional division unit 208 calculates an estimated velocity in accordance with the following Expression.

EV=(s/t)×v1(s)+((t−s)/t)×v2(s) Expression (9)
EV: Estimated velocity
v1(s): Velocity subjected to addition at the time of the unreceiving section s
v2(s): Velocity subjected to subtraction at the time of the unreceiving section s

When calculating Expression (9) with causing the unreceiving section s to vary from “1” to “t”, it may be possible for the proportional division unit 208 to calculate a likely value with respect to the velocity of the vehicle in the unreceiving section. The proportional division unit 208 stores the calculated estimated velocity in the second storage unit 106.

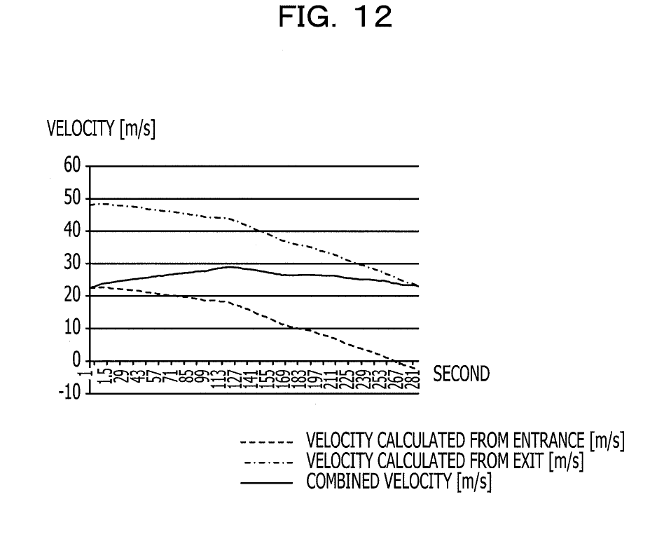

FIG. 12 is a diagram illustrating an example of a value obtained by combining a velocity calculated from an entrance and a velocity calculated from an exit. A dotted line illustrated in FIG. 12 indicates a velocity obtained when the acceleration acquired from the acceleration correction unit 204 continues to be added to a velocity at the entrance of the unreceiving section. A dashed-dotted line illustrated in FIG. 12 indicates a velocity obtained when the acceleration acquired from the acceleration correction unit 204 continues to be subtracted from a velocity at the exit of the unreceiving section. A solid line illustrated in FIG. 12 indicates a combined value due to the proportional division of the velocity subjected to addition and the velocity subjected to subtraction.

The reason why the combined value is calculated is because a value, obtained by multiplying the acquisition result of the acceleration sensor by a correlation coefficient and adding a correlation value to the acquisition result, is not the preferable acceleration of the vehicle. Accordingly, when an acceleration acquired by the triaxial acceleration sensor 105 continues to be added to a velocity at a point at which the radio wave has been finally received from the GPS satellite, as a result, a velocity obtained owing to the addition processing significantly differs from a velocity obtained when the radio wave has been received from the GPS satellite again at the exist of the unreceiving section.

Accordingly, the subtraction unit 207 calculates a velocity from which the acceleration calculated in the unreceiving section is subtracted, with respect to a vehicle velocity received owing to the radio wave from the GPS satellite at the exist of the unreceiving section. With respect to a velocity within the unreceiving section, the proportional division unit 208 calculates a combined value obtained by proportionally dividing the rates of the velocity to which the acceleration has continued to be added from the entrance of the unreceiving section and the velocity from which the acceleration has continued to be subtracted from the exit thereof, on the basis of the number of the sections of the unreceiving section.

Accordingly, even in a section in which it is hard to receive the GPS signal from the GPS satellite, it may be possible for the mobile terminal device 100 to calculate the adequate velocity of the vehicle. The velocity of the vehicle stored in the second storage unit 106 is stored in an SD card or the like, for example.

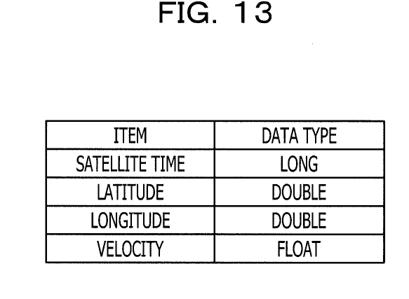

Next, the data structure of data used in the velocity calculation processing will be described. FIG. 13 is a diagram illustrating an example of GPS information (also referred to as satellite information) from a GPS satellite. In the example illustrated in FIG. 13, the GPS information includes a satellite time (also referred to as a GPS time), a latitude, a longitude, and a velocity. This velocity corresponds to the GPS velocity.

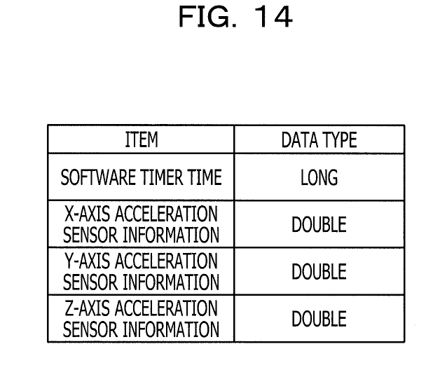

FIG. 14 is a diagram illustrating an example of sensor information. In the example illustrated in FIG. 14, the sensor information includes a software timer time (also referred to as a sensor time) and the output value of each axis of the triaxial acceleration sensor 105.

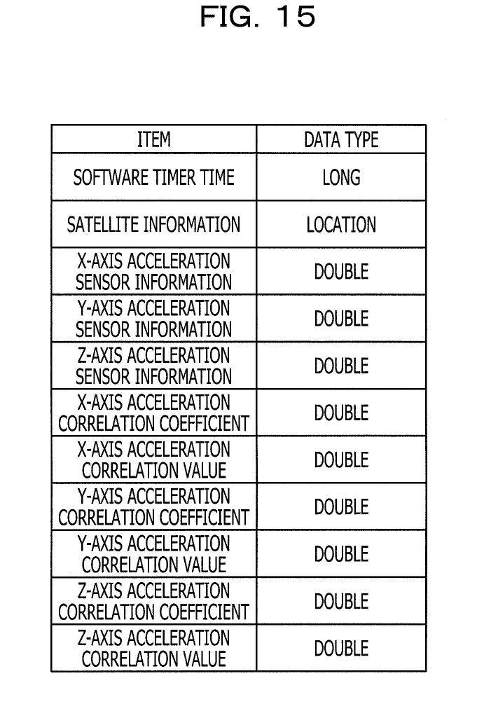

FIG. 15 is a diagram illustrating an example of location information. In the example illustrated in FIG. 15, the location information includes a software timer time, satellite information, the output value (acceleration) of each axis of the triaxial acceleration sensor 105 at this location, the correlation coefficient of each axis thereof, and the correlation value of each axis thereof.

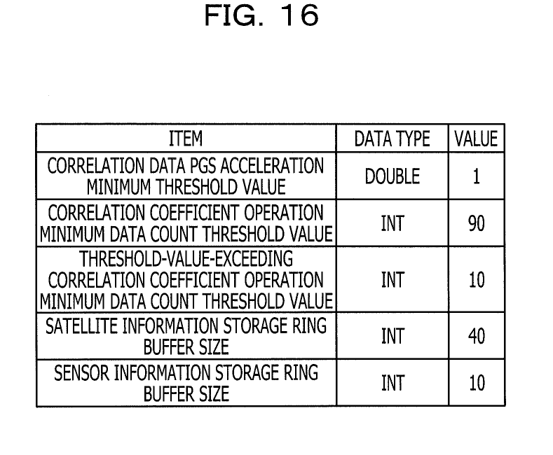

FIG. 16 is a diagram illustrating an example of a parameter. In the example illustrated in FIG. 16, the parameter includes a threshold value used for the calculation of the velocity, the size of a ring buffer storing therein the satellite information, the size of a ring buffer storing therein the sensor information, and the like.

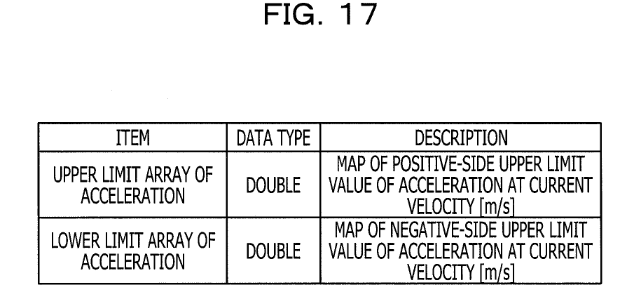

FIG. 17 is a diagram illustrating an example of information relating to the upper limit value and the lower limit of acceleration. The upper limit value of acceleration and the lower limit of acceleration with respect to a current velocity, illustrated in FIG. 17, are used by the acceleration correction unit 204. A range extending from the upper limit value of acceleration to the lower limit value thereof is a predetermined range.

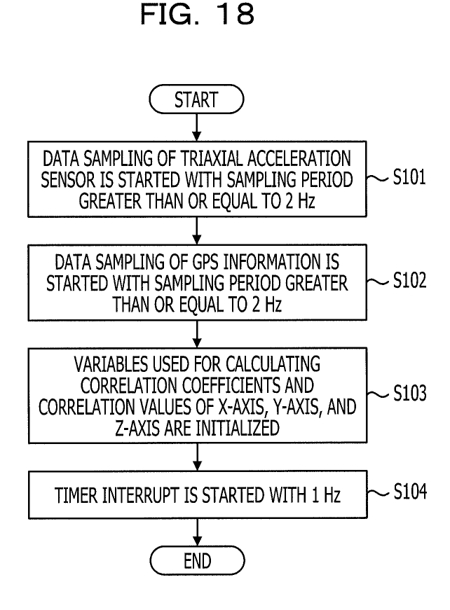

Next, the operation of the mobile terminal device 100 in the first embodiment will be described. FIG. 18 is a flowchart illustrating an example of measurement start processing for a velocity in the first embodiment. The processing illustrated in FIG. 18 is processing performed when a processing start is ordered from the application main screen of the mobile terminal device.

In Operation S101, the controller 101 starts data sampling of the triaxial acceleration sensor 105 with the sampling period thereof being greater than or equal to 2 Hz. The reason why the sampling period is set to a sampling period greater than or equal to 2 Hz is because data is acquired in a time period less than or equal to 1 second.

In Operation S102, the controller 101 starts data sampling of the GPS information due to the GPS processor 102 with the sampling period thereof being greater than or equal to 2 Hz.

In Operation S103, the controller 101 initializes variables used for calculating the correlation coefficients and the correlation values of the X-axis, Y-axis, and Z-axis of the triaxial acceleration sensor 105.

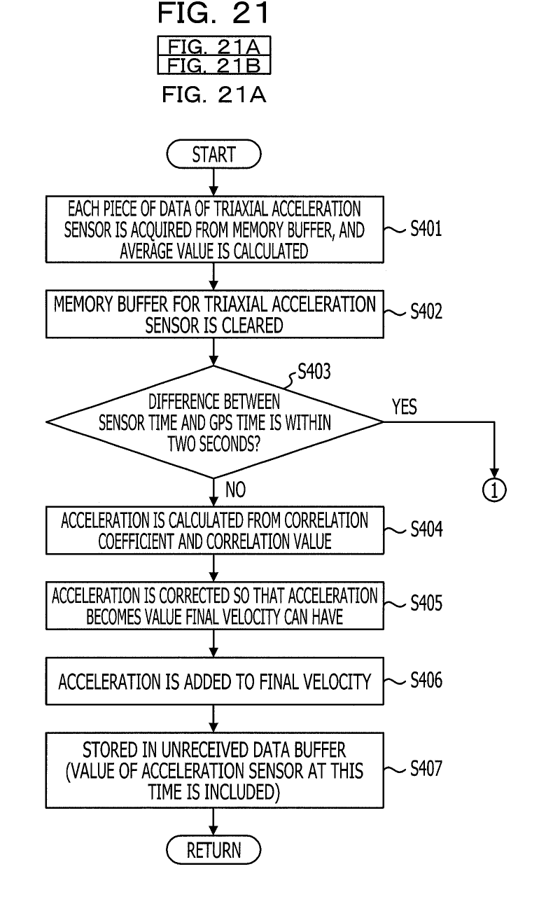

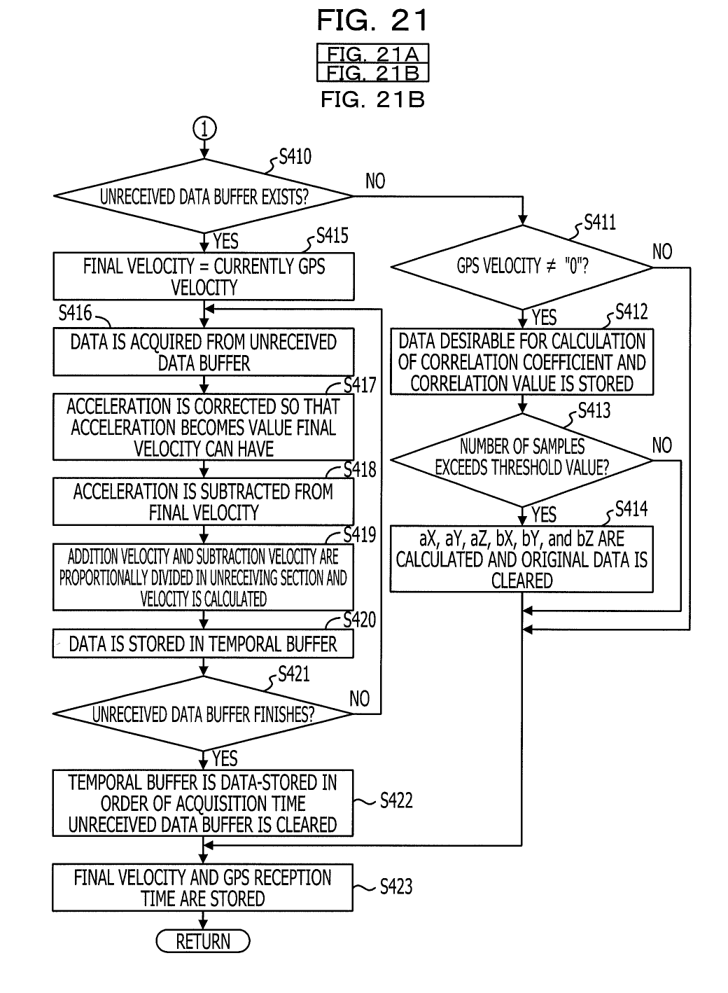

In Operation S104, the controller 101 performs activation processing for a (software) timer interrupt with 1 Hz, for example. The activation processing for a timer interrupt will be described using FIGS. 21A and 21B.

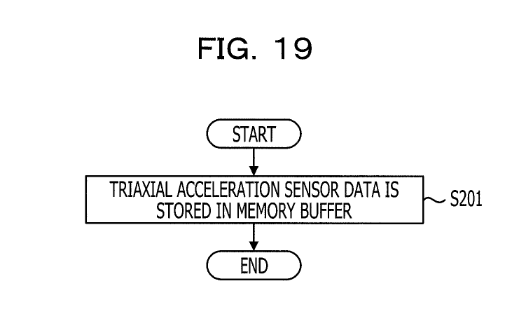

FIG. 19 is a flowchart illustrating an example of acquisition processing for each piece of data in the triaxial acceleration sensor 105 in the first embodiment. In Operation S201 illustrated in FIG. 19, the triaxial acceleration sensor 105 stores acquired data of each axis in a memory buffer. For example, the memory buffer is a ring buffer (hereinafter, also referred to as a sensor information ring buffer), and a part of the second storage unit 106.

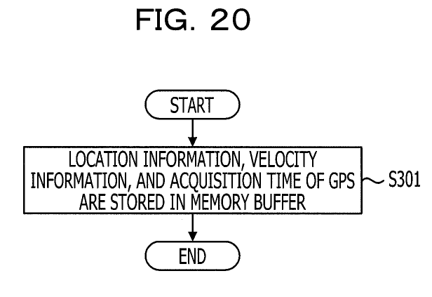

FIG. 20 is a flowchart illustrating an example of acquisition processing for GPS information in the GPS processor 102 in the first embodiment. In Operation S301 illustrated in FIG. 20, the GPS processor 102 processes a GPS signal, and stores the location information, the velocity information, and the acquisition time of GPS in a memory buffer. For example, the memory buffer is a ring buffer (hereinafter, also referred to as a satellite information ring buffer), and a part of the second storage unit 106. The reason why the ring buffer is used as the memory buffer will be described later.

FIGS. 21A and 21B are flowcharts illustrating an example of velocity measurement processing in the first embodiment. In Operation S401 illustrated in FIG. 21A, the correlation calculation unit 202 acquires each piece of data of the triaxial acceleration sensor 105 from the memory buffer, and calculates an average value every one second. This average value of each axis is used as the data of each axis in processing to be performed hereinafter.

In Operation S402, when having finished calculating the average value, the correlation calculation unit 202 clears the memory buffer for the triaxial acceleration sensor 105.

In Operation S403, the velocity calculation unit 103 determines whether a difference between a time (also referred to as a sensor time) when data has been acquired from the triaxial acceleration sensor 105 and a time (also referred to as a GPS time) when the GPS processor 102 has acquired the GPS information is within two seconds, for example. When the time difference is within two seconds (S403: YES), the processing shifts to processing in FIG. 21B, and when the time difference is larger than two seconds (Operation S403: NO), the processing proceeds to Operation S404.

Here, when the time difference is within two seconds, the velocity calculation unit 103 determines that the GPS information has been normally acquired, and when the time difference is larger than two seconds, the velocity calculation unit 103 determines that it has been hard to receive the GPS information, owing to entering a tunnel or the like, for example.

Operations S404 to S407 illustrate processing performed in the unreceiving section in which it is hard to receive the GPS information. In Operation S404, the acceleration calculation unit 203 acquires a correlation coefficient and a correlation value between a GPS velocity and each piece of data of the triaxial acceleration sensor 105, from the second storage unit 106. The acceleration calculation unit 203 calculates an acceleration using this correlation value, this correlation coefficient, and each piece of data of the triaxial acceleration sensor 105 within the unreceiving section. At this time, while two axes whose correlation coefficients are large are used, using Expression (4) the acceleration calculation unit 203 may weight accelerations obtained from the two axes with the individual correlation coefficients thereof, thereby calculating one acceleration.

In Operation S405, when the calculated acceleration exceeds a variable amount (refer to FIG. 11) for the velocity, the acceleration correction unit 204 corrects the acceleration so that the acceleration becomes the upper limit value or the lower limit value.

In Operation S406, the addition unit 206 adds the acceleration to a final velocity, and calculates a velocity. Hereinafter, this velocity will be referred to as an addition velocity. The final velocity at this time is a GPS velocity acquired in front of the entrance of the unreceiving section.

In Operation S407, the addition unit 206 stores the addition velocity in an unreceived data buffer, along with the value of the triaxial acceleration sensor 105 at this time. For example, the unreceived data buffer is a part of the second storage unit 106.

In processing in Operations S404 to S407, it may be possible to calculate the addition velocity within the unreceiving section. At this time, the correlation coefficient and the correlation value, which have been used for the acceleration calculation, are stored in the unreceived data buffer.

The processing illustrated in FIG. 21B is processing performed when it may be possible to normally receive the GPS velocity.

In Operation S410 illustrated in FIG. 21B, the velocity calculation unit 103 determines whether data exists in the unreceived data buffer. When the data exists (Operation S410: YES), the processing proceeds to Operation S414, and when the data does not exist (Operation S410: NO), the processing proceeds to Operation S411.

Operations S411 to S413 correspond to processing for updating the correlation coefficient and the correlation value between the GPS velocity and each piece of data of the triaxial acceleration sensor 105. Since the attitude of the mobile terminal device 100 may change, update processing for the correlation coefficient and the correlation value are regularly performed.

In Operation S411, the GPS velocity acquisition unit 201 acquires the GPS velocity from the second storage unit 106, and determines whether the GPS velocity is a non-zero value. When the GPS velocity is a non-zero value (Operation S411: YES), the processing proceeds to Operation S412, and when the GPS velocity is not a non-zero value (Operation S411: NO), the processing proceeds to Operation S423.

In Operation S412, the correlation calculation unit 202 stores therein data desirable for the calculation of the correlation coefficient and the correlation value. Here, when the correlation coefficient is calculated on the basis of a least-square method, the desirable data includes the sum of individual pieces of data of the triaxial acceleration sensor 105, the sum of the GPS accelerations, the sum of the products of individual pieces of data and the GPS accelerations, the sum of the squares of individual pieces of data, and the number of pieces of data.

In Operation S413, the correlation calculation unit 202 determines whether the number of pieces of stored data exceeds a threshold value. For example, as for the threshold value, it is assumed that the number of pieces of data is 90 and the number of pieces of data where a change in the acceleration is greater than or equal to 1 m/s² is 10 (refer to FIG. 16). When the number of pieces of data exceeds a threshold value, the correlation calculation unit 202 calculates the correlation coefficients aX, aY, and aZ and the correlation values bX, bY, and bZ in accordance with Expressions (1) to (3), using the least-square method. The correlation calculation unit 202 updates original data using the calculated new correlation coefficients and the calculated new correlation values.

Accordingly, when sample data exceeds the threshold value in a section in which the GPS information is normally received, it may be possible to update the correlation coefficients and the correlation values.

Operations S415 to S422 correspond to processing for retroactively calculating a velocity in the unreceiving section on the basis of the GPS velocity that has been able to be acquired after the unreceiving section when the vehicle has gone out of the section.

In Operation S415, the GPS velocity acquisition unit 201 sets the final velocity to the currently acquired GPS velocity. The GPS velocity acquisition unit 201 outputs the final velocity to the subtraction unit 207.

In Operation S416, the acceleration calculation unit 203 acquires, from the unreceived data buffer, an acceleration calculated from the correlation coefficient and the correlation value in the unreceiving section, calculated in Operation S404.

In Operation S417, the acceleration correction unit 204 corrects the acceleration, acquired from the unreceived data buffer by the acceleration calculation unit 203, so that the acceleration becomes a value the final velocity may have. The acceleration correction unit 204 outputs, to the subtraction unit 207, the acceleration after the correction.

In Operation S418, the subtraction unit 207 sequentially subtracts, from the final velocity, an acceleration, starting from the acceleration at the exist of the unreceiving section, and calculates a velocity backward from the exist of the unreceiving section to the entrance thereof. Hereinafter, the velocity will be referred to as a subtraction velocity.

In Operation 5419, the proportional division unit 208 acquires the addition velocity and the subtraction velocity from the addition unit 206 and the subtraction unit 207, respectively, and calculates a velocity (estimated velocity) by proportionally dividing the addition velocity and the subtraction velocity in the unreceiving section.

In Operation S420, the estimated velocity calculation unit 205 stores the calculated estimated velocity in a temporal buffer. For example, the temporal buffer is the second storage unit 106.

In Operation S421, the velocity calculation unit 103 determines whether no data exists in the unreceived data buffer. If data exists (Operation S421: NO), the processing proceeds to Operation S416, and when no data exists (Operation S421: YES), the processing proceeds to Operation S422.

In Operation S422, the second storage unit 106 stores therein the temporal buffer in order of the acquisition time of data (in order, from the entrance of unreceiving section to the exist thereof).

In Operation S423, the GPS processor 102 stores the final velocity and a GPS reception time in the satellite information ring buffer, for example. Accordingly, after the vehicle has gone out of the unreceiving section, it may be possible to retroactively calculate a likely velocity in the unreceiving section.

The calculated velocity in the unreceiving section may be stored in another recording medium such as an SD card or the like, along with the GPS velocities or the like before and after the unreceiving section.

Next, the reason why ring buffers are used for the GPS information and the sensor information will be described. First, an update interrupt for the GPS information and a software timer interrupt used for acquiring the sensor information occur independently as threads different from each other. Furthermore, as for the GPS information, in a section in which it is hard to receive the GPS radio wave, an interrupt does not occur. In addition, when the OS of the mobile terminal device is subjected to a load, the interrupt timing of the software timer interrupt is also delayed.

When an interrupt does not occur in an interval time in which the software timer interrupt is designated, the interrupt queue thereof is ignored and the interrupt itself does not occur.

Accordingly, even if the acquisition result of the GPS information is retrieved at the instant of the software timer interrupt, there occurs a phenomenon that the GPS information has not been updated or it is hard to acquire the GPS information at a correct timing, owing to the delay of an update operation.

In order to solve this phenomenon, the GPS information and the sensor information acquired owing to the software timer interrupt are stored in ring buffers different from each other, and the sensor information is compared with the GPS information after a given period of time has elapsed since the sensor information has been acquired. Accordingly, the synchronization of both pieces of data is achieved.

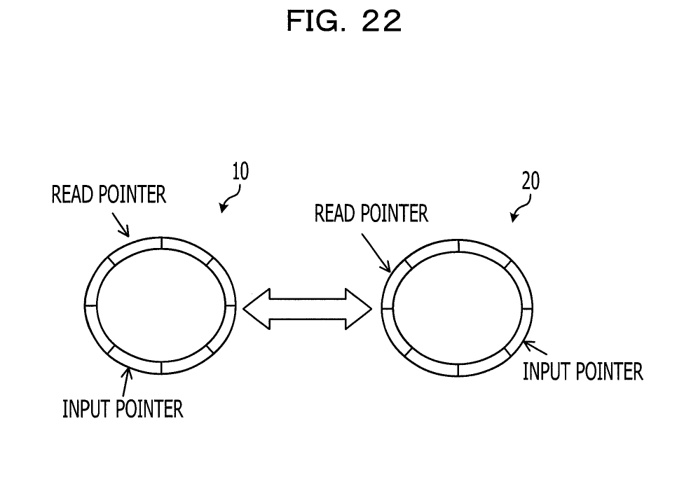

FIG. 22 is a diagram illustrating an example of initializing processing for synchronizing GPS information and sensor information with each other. It is desirable for a satellite information ring buffer 10 illustrated in FIG. 22 to be more than twice a sensor information ring buffer 20, in terms of time. If, in terms of time, the satellite information ring buffer 10 has the same size as the sensor information ring buffer 20, GPS information at a synchronization time with respect to the sensor information may be updated by new GPS information.

The interrupt for the GPS information update is implemented at a timing at which the GPS processor 102 acquires new GPS information.

The GPS information acquired by the GPS processor 102 is stored in the ring buffer indicated by an input pointer, and the input pointer is moved forward by one.

When the input pointer has caught up with a read pointer, the read pointer is moved forward by one.

At the beginning of measurement, the satellite information ring buffer 10 is filled with an amount of data corresponding to at least one loop.

As for the sensor information, a program is generated at the timing of the software timer interrupt. The read pointer of the sensor information ring buffer 20 is located posterior to the input pointer by a half of one loop.

The matching processing for the sensor information and the GPS information is implemented for data posteriorly located by a half of one loop in the sensor information ring buffer 20. Accordingly, it is desirable to accumulate data first so that the data occupies more than half of the size of the sensor information ring buffer 20.

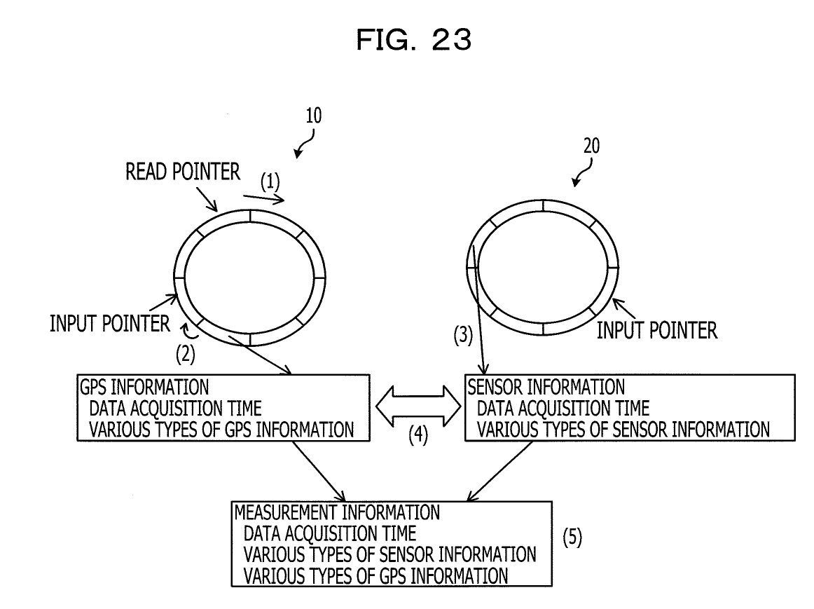

FIG. 23 is a diagram illustrating an example of processing performed when the software timer interrupt normally occurs. The processing illustrated in FIG. 23 is processing performed when the software timer interrupt has occurred at an expected timing and a desirable amount of data has been already accumulated in the ring buffer.

(1) From the read pointer of the satellite information ring buffer 10, the GPS information nearest to the data acquisition time of the sensor information is searched.

(2) When the acquisition time of the GPS information in a subsequent buffer is smaller than the acquisition time in the current buffer, it is determined that the read pointer has caught up with the input pointer, and the search is terminated.

(3) The sensor information is acquired from a buffer located posterior to the input pointer of the sensor information ring buffer 20 by a half of one loop.

(4) When a difference between the data acquisition time (GPS time) of the acquired GPS information and the data acquisition time (sensor time) of the acquired sensor information falls within two seconds, the velocity calculation unit 103 determines that the GPS information has been normally received.

(5) The GPS information where it is determined that the GPS information has been normally received and the sensor information may be put into one piece of information and stored in the second storage unit 106, as measurement information. The measurement information includes a data acquisition time, the sensor information, and GPS information. One of the GPS time, the sensor time, and the average of the GPS time and the sensor time may be used as the data acquisition time of the measurement information.

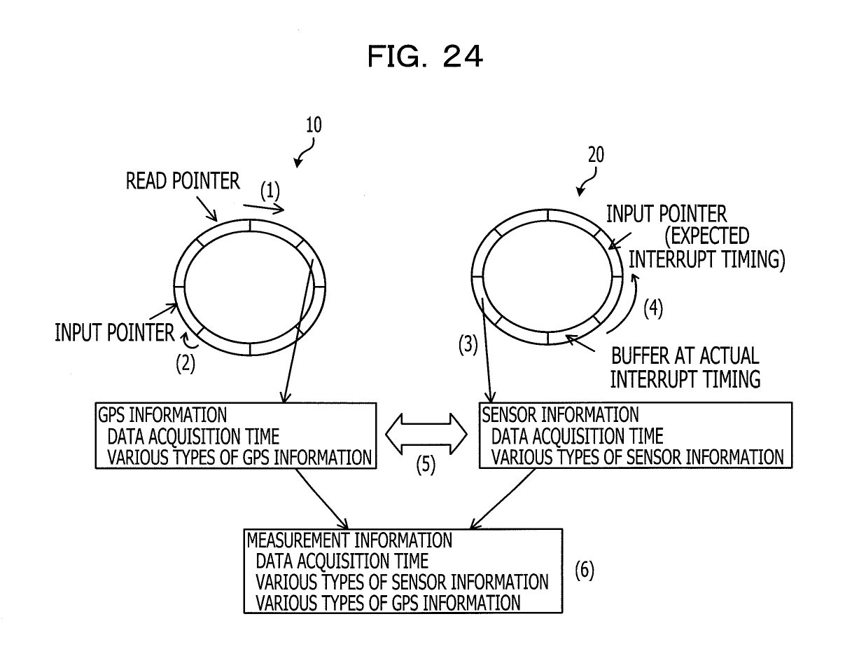

FIG. 24 is a diagram illustrating an example of processing performed when the software timer interrupt is omitted. The processing illustrated in FIG. 24 is processing performed when the software timer interrupt has not occurred at an expected timing.

(1) From the read pointer of the satellite information ring buffer 10, the GPS information nearest to the data acquisition time of the sensor information is searched.

(2) When the acquisition time of the GPS information in a subsequent buffer is smaller than the acquisition time in the current buffer, it is determined that the read pointer has caught up with the input pointer, and the search is terminated.

(3) The sensor information is acquired from a buffer located posterior to the input pointer of the sensor information ring buffer 20 by a half of one loop.

(4) Since the software timer interrupt is omitted, the sensor information is copied and registered with respect to a time from an expected interrupt timing to an actual interrupt time. Every time the information of the omitted software timer interrupt is added, processing for comparison with the GPS information is performed.

(5) When a difference between the data acquisition time (GPS time) of the acquired GPS information and the data acquisition time (sensor time) of the acquired sensor information falls within two seconds, the velocity calculation unit 103 determines that the GPS information has been normally received.

(6) The GPS information where it is determined that the GPS information has been normally received and the sensor information may be put into one piece of information and stored in the second storage unit 106, as measurement information. The measurement information includes a data acquisition time, the sensor information, and GPS information.

Accordingly, the GPS information and the sensor information acquired owing to the software timer interrupt are stored in ring buffers different from each other, and the sensor information is compared with the GPS information after a given period of time has elapsed since the sensor information has been acquired. Accordingly, it may be possible to achieve the synchronization of both pieces of data.

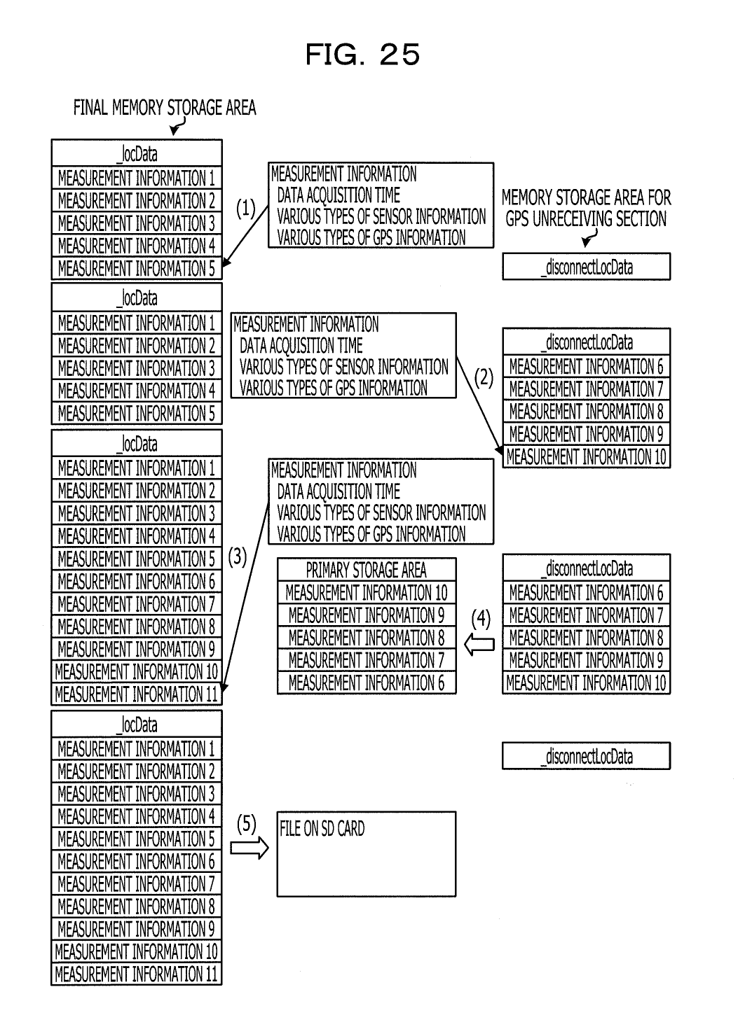

Next, the processing procedure of measurement information including the sensor information and the GPS information will be described. FIG. 25 is a diagram illustrating an example of the processing procedure of the measurement information.

(1) When the GPS information has been normally received, the velocity calculation unit 103 stores pieces of measurement information 1 to 5 in a final memory storage area (hereinafter, referred to as an area A). For example, the final memory storage area is a part of the second storage unit 106.

(2) When the GPS information has not been normally received, the velocity calculation unit 103 stores pieces of measurement information 6 to 10 in a memory storage area for a GPS unreceiving section (hereinafter, referred to as an area B).

(3) When the GPS information has been received again, the velocity calculation unit 103 stores a piece of measurement information 11 in the area A.

(4) Using the GPS velocity received again and each piece of data of the triaxial acceleration sensor 105, the velocity calculation unit 103 calculates a velocity in accordance with the above-mentioned processing. The velocity calculation unit 103 stores the pieces of measurement information 6 to 10 including the calculated velocity in the area A.

(5) When the area B is empty, and data whose amount is a given amount or more has been stored in the area A, the controller 101 outputs the data to a file, and deletes the data from the area A. The file may be a storage unit within a device or an external SD card or the like. In the example illustrated in FIG. 25, it is assumed that the data is output to a file on an SD card.

As described above, according to the first embodiment, when the velocity of the vehicle is measured using the mobile terminal device 100, it may be possible to measure an adequate velocity even in the unreceiving section in which it is hard to receive the GPS information. In addition, according to the first embodiment, since geometric calculation is not implemented, initializing processing such as the designation of orthogonality between a sensor and the earth's axis or the like is redundant. In addition, by regularly updating a correlation, it may be possible to deal with a change in the attitude of the mobile terminal device.

In addition, the velocity calculation unit 103 may use a method other than the method for proportionally dividing the addition velocity and the subtraction velocity and calculating the estimated velocity. For example, the velocity calculation unit 103 may connect the GPS velocity received before the entrance of the unreceiving section and the GPS velocity received after the exit of the unreceiving section to each other, using a linear function. The velocity calculation unit 103 may use a method in which an acceleration calculated at that time is added to that velocity expressed by the linear function, thereby correcting the velocity expressed by the linear function.

Next, a mobile terminal device 300 in a second embodiment will be described. In the second embodiment, the mobile terminal device 300 corrects a velocity calculated in the unreceiving section, using data due to an atmospheric pressure sensor.

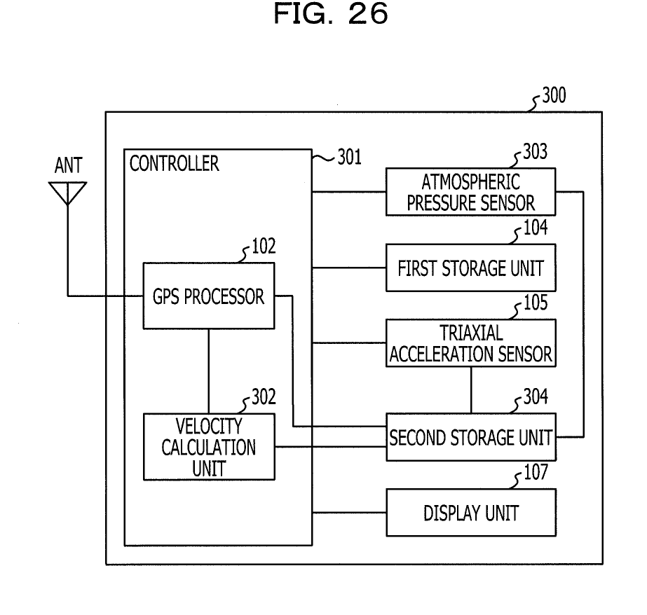

FIG. 26 is a block diagram illustrating an example of the configuration of the mobile terminal device 300 in the second embodiment. In the configuration illustrated in FIG. 26, a same symbol is assigned to the same as the configuration illustrated in FIG. 7, and the description thereof will be omitted.

In addition to the control described in the first embodiment, a controller 301 controls an atmospheric pressure sensor 303. The controller 301 includes a velocity calculation unit 302.

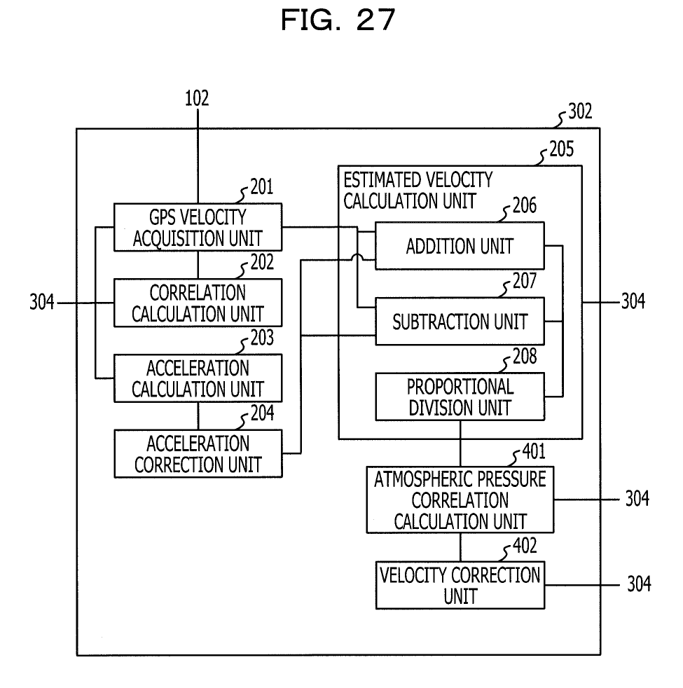

When the calculated velocity has a correlation with the data of the atmospheric pressure sensor 303, the velocity calculation unit 302 corrects the velocity. The detail of the velocity calculation unit 302 will be described later using FIG. 27.

The atmospheric pressure sensor 303 is controlled by the controller 101, and samples atmospheric pressure data with 2 Hz, for example. The sampled data is stored in the second storage unit 304.

In addition to the various kinds of data described in the first embodiment, the second storage unit 304 stores therein the atmospheric pressure data acquired by the atmospheric pressure sensor 303.

FIG. 27 is a block diagram illustrating an example of the configuration of the velocity calculation unit 302 in the second embodiment. In the configuration illustrated in FIG. 27, a same symbol is assigned to the same as the configuration illustrated in FIG. 8, and the description thereof will be omitted.

An atmospheric pressure correlation calculation unit 401 illustrated in FIG. 27 calculates a correlation coefficient and a correlation value between the acceleration calculated in the unreceiving section and a change in the atmospheric pressure data (atmospheric pressure). If a negative first order correlative relationship occurs in this correlation coefficient, it may be determined that an acceleration has changed owing to a change in a gradient.

When there is a negative first order correlative relationship between the acceleration in the unreceiving section and a change in the atmospheric pressure, a velocity correction unit 402 corrects the velocity in the unreceiving section. For example, the velocity correction unit 402 corrects the velocity in accordance with following Expression.

Velocity=velocity−atmospheric pressure data×aP+bP Expression (10)

aP: a correlation coefficient between an acceleration and atmospheric pressure data

bP: a correlation value between an acceleration and atmospheric pressure data

The velocity correction unit 402 stores the corrected velocity in the second storage unit 304 with the corrected velocity being included in the measurement information.

Next, a relationship between an atmospheric pressure and an acceleration will be described. In the unreceiving section such as a tunnel or the like, in the calculation of the velocity due to the acceleration, there occurs a phenomenon that the velocity is totally accelerated or decelerated.

Since a correlation between the GPS acceleration and the triaxial acceleration sensor has been calculated before the vehicle enters the tunnel, when the gradient of a road has changed in the tunnel, the earth's axis may change, compared with the time of correlativity calculation. Therefore, this phenomenon is considered to occur.

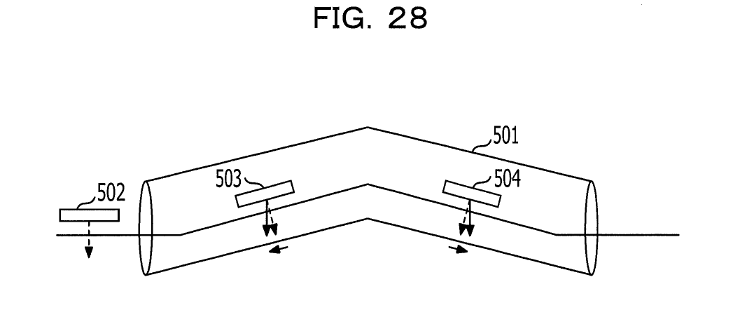

FIG. 28 is a diagram illustrating a change in the direction of the earth's axis due to a change in a road gradient within the unreceiving section. As for arrows from the mobile terminal device, illustrated in FIG. 28, the directions of the earth's axis, recognized by the mobile terminal device, are indicated by dotted line arrows, and the actual directions of the earth's axis are indicated by solid line arrows.

In the state 502 of the mobile terminal device 300 before a tunnel 501, illustrated in FIG. 28, a correlation is calculated. In addition, in the state 503 of the mobile terminal device 300 in the tunnel 501, owing to a difference from the actual earth's axis, the mobile terminal device 300 misunderstands that the mobile terminal device 300 is accelerated. In addition, in the state 504 of the mobile terminal device 300 in the tunnel 501, owing to a difference from the actual earth's axis, the mobile terminal device 300 misunderstands that the mobile terminal device 300 is decelerated.

In order to solve this phenomenon, it is desirable to understand how the road gradient has changed in the unreceiving section. As a tool for understanding a change in the road gradient, a change in the atmospheric pressure is used. A first order correlative relationship occurs between a change in the atmospheric pressure and the acceleration of a velocity calculated within the unreceiving section. Since a correlation is verified only within the unreceiving section, it is desirable to only provide short-term data samples. In addition, since a correlation between differential values is calculated, there is no influence of a weather condition.

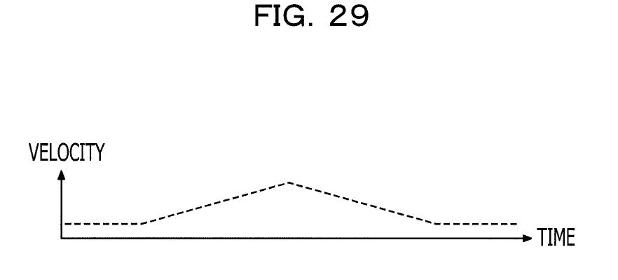

FIG. 29 is a diagram illustrating an example of a velocity calculated within the unreceiving section using the triaxial acceleration sensor 105. As illustrated in FIG. 29, a velocity increases in a section mistaken for acceleration, and a velocity decreases in a section mistaken for deceleration.

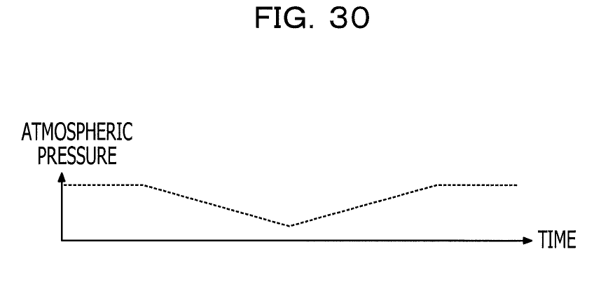

FIG. 30 is a diagram illustrating an example of a change in an atmospheric pressure due to a change in a gradient. As illustrated in FIG. 30, a negative first order correlative relationship occurs between the differential value (acceleration) of the velocity with respect to a temporal axis illustrated in FIG. 29 and the differential value of a change in the atmospheric pressure with respect to a temporal axis.

Accordingly, the mobile terminal device 300 calculates a correlation with the atmospheric pressure after calculating the velocity in the unreceiving section, and subtracts an acceleration corresponding to the correlation with the atmospheric pressure. Therefore, it may be possible for the mobile terminal device 300 to remove the influence of a change in the road gradient on the velocity.

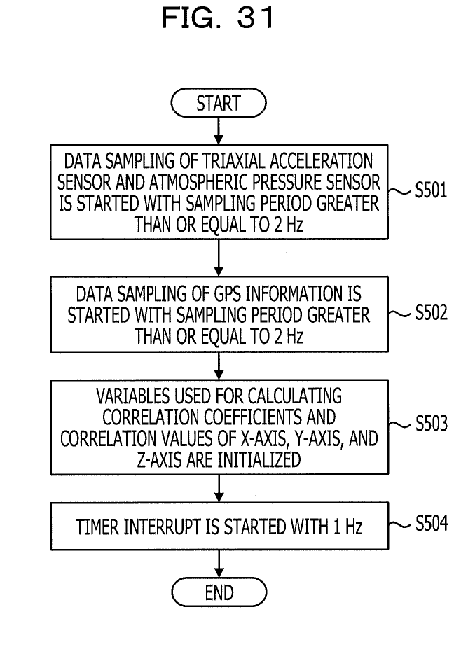

Next, the operation of the mobile terminal device 300 in the second embodiment will be described. FIG. 31 is a flowchart illustrating an example of measurement start processing for a velocity in the second embodiment. The processing illustrated in FIG. 31 is processing performed when a processing start is ordered from the application main screen of the mobile terminal device.

In Operation S501, the controller 301 starts data sampling of the triaxial acceleration sensor 105 and the atmospheric pressure sensor 303 with the sampling period thereof being greater than or equal to 2 Hz. The reason why the sampling period is set to a sampling period greater than or equal to 2 Hz is because data is acquired in a time period less than or equal to 1 second.

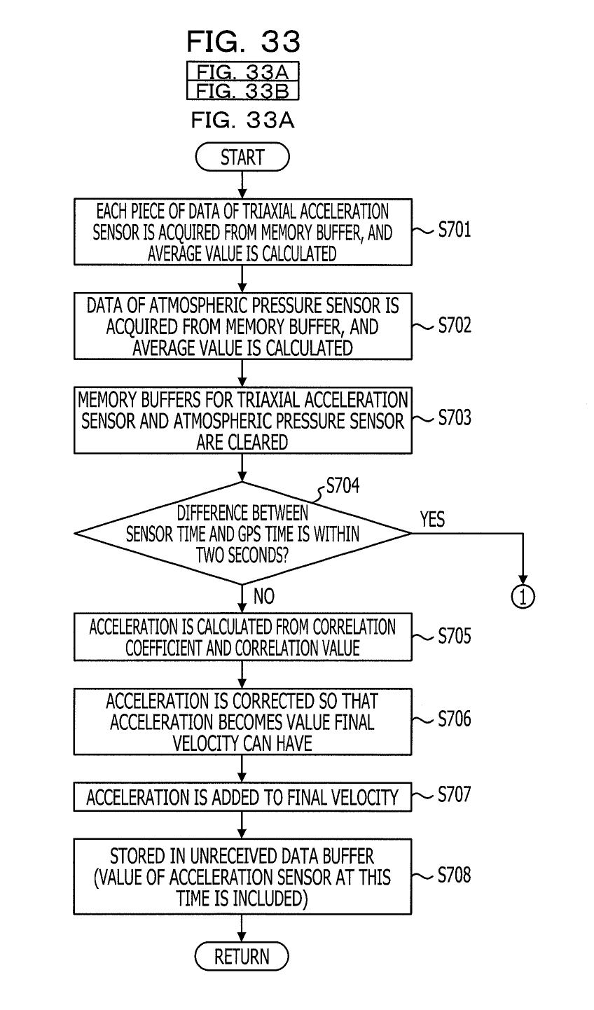

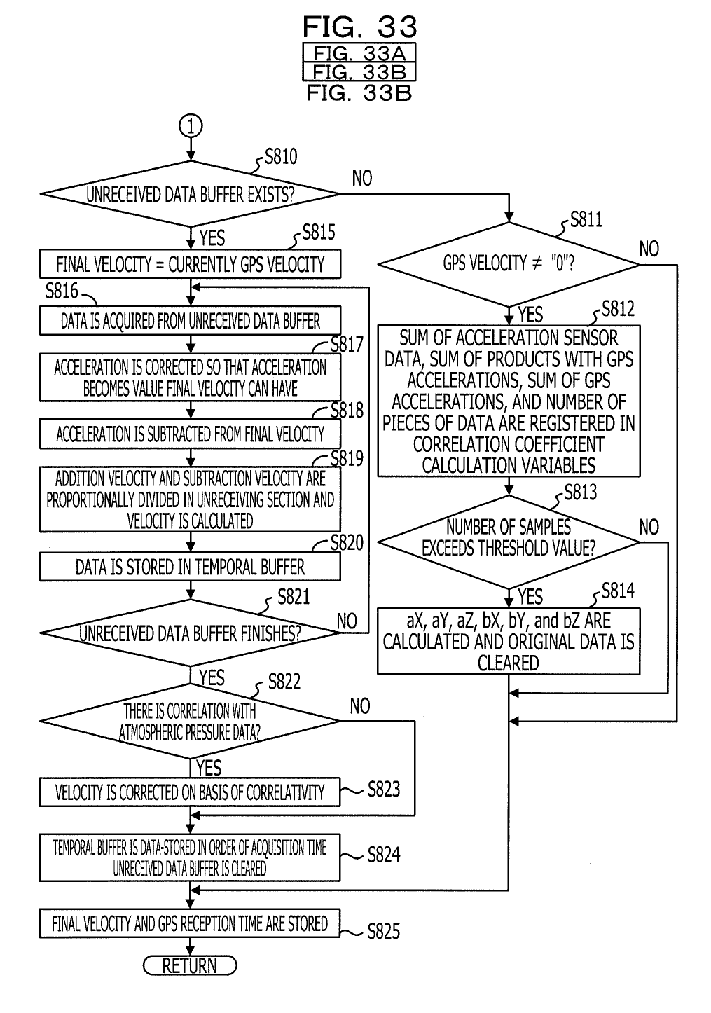

Processing performed in Operations S502 and S503 is the same as in the first embodiment. In Operation S504, the controller 301 performs activation processing for a (software) timer interrupt with 1 Hz, for example. The activation processing for a timer interrupt will be described using FIGS. 33A and 33B.

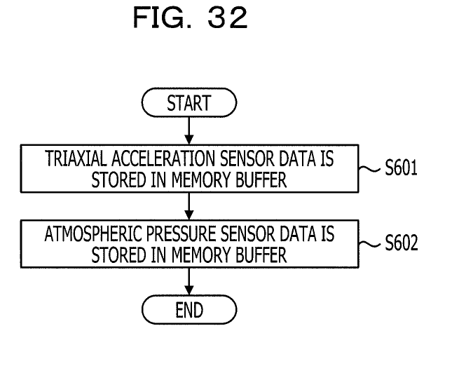

FIG. 32 is a flowchart illustrating an example of acquisition processing for each piece of data in each sensor in the second embodiment. In Operation S601 illustrated in FIG. 32, the triaxial acceleration sensor 105 stores acquired data of each axis in a memory buffer. The memory buffer is a part of the second storage unit 106.

In Operation S602, the atmospheric pressure sensor 303 stores the acquired atmospheric pressure data in a memory buffer. The memory buffer is a part of the second storage unit 304.

FIGS. 33A and 33B are flowcharts illustrating an example of velocity measurement processing in the second embodiment. In Operation S701 illustrated in FIG. 33A, the correlation calculation unit 202 acquires each piece of data of the triaxial acceleration sensor 105 from the memory buffer, and calculates an average value every one second. This average value of each axis is used as the data of each axis in processing to be performed hereinafter.

In Operation S702, the atmospheric pressure correlation calculation unit 401 acquires the atmospheric pressure data of the atmospheric pressure sensor 303 from the memory buffer, and calculates an average value every one second.

In Operation S703, when having finished calculating the individual average values thereof, the correlation calculation unit 202 and the atmospheric pressure correlation calculation unit 401 clear the individual memory buffers thereof.

Since processing performed in Operations S704 to S708 is the same as in the processing performed in Operations S403 to S407 in FIG. 21A, the description thereof will be omitted.

Since processing performed in Operations S810 to S821 illustrated in FIG. 33B is the same as in the processing performed in Operations S410 to S421 illustrated in FIG. 21B, the description thereof will be omitted.

In Operation S822, the velocity correction unit 402 determines whether a negative first order correlative relationship exists between the atmospheric pressure data of the atmospheric pressure sensor 303 and the acceleration in the unreceiving section. When the correlation exists (Operation S822: YES), the processing proceeds to Operation S823, and when the correlation does not exist (Operation S822: NO), the processing proceeds to Operation S824.

In Operation S823, on the basis of the correlation coefficient and the correlation value between the acceleration and the atmospheric pressure data in the unreceiving section, the velocity correction unit 402 corrects the calculated velocity. For example, the velocity correction unit 402 corrects the velocity using Expression (10).

In Operation S824, the velocity correction unit 402 stores the corrected velocity or the uncorrected velocity in a temporal buffer. For example, the temporal buffer is a part of the second storage unit 304.

In Operation S825, the GPS processor 102 stores a final velocity and the GPS reception time in the satellite information ring buffer, for example.

The calculated velocity in the unreceiving section may be stored in another recording medium such as an SD card or the like, along with GPS velocities before and after the unreceiving section.

As described above, according to the second embodiment, while having the same advantageous effect as the first embodiment, it may be possible to remove a change in the acceleration due to a change in the road gradient.

In addition, as the mobile terminal device described in each of the embodiments, an information processing device equipped with a GPS function and a triaxial acceleration sensor may be applied. In addition, a velocity calculated in each embodiment may be regarded as the velocity in the unreceiving section, and may be used for the above-mentioned economical drive guidance or the like.

In addition, in each embodiment, in place of the triaxial acceleration sensor, a plurality of single-axis acceleration sensors may be combined and applied.

In addition, by recording, in a recording medium, a program for realizing the velocity calculation processing described in each embodiment, it may be possible to cause a computer to implement the velocity calculation processing in each embodiment. For example, this program may be recorded in a recording medium, and a computer or a mobile terminal device may be caused to read the recording medium in which this program is recorded. Therefore, it may be possible to realize the above-mentioned velocity calculation processing.

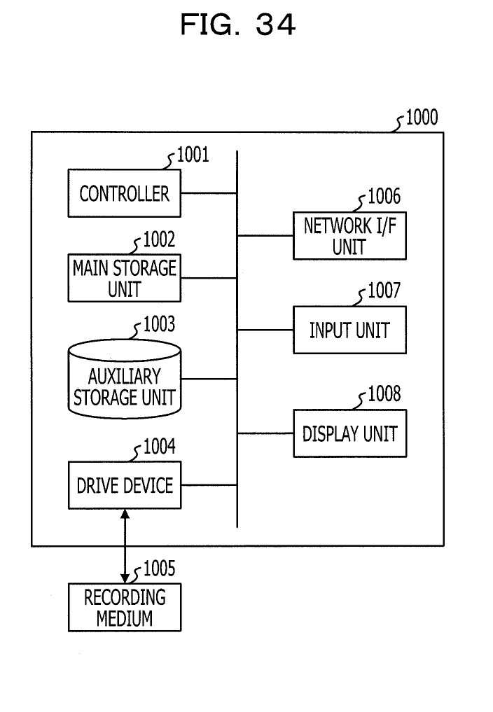

FIG. 34 is a diagram illustrating an example of the configuration of a mobile terminal device 1000. As illustrated in FIG. 34, the mobile terminal device 1000 includes a controller 1001, a main storage unit 1002, an auxiliary storage unit 1003, a drive device 1004, a network I/F unit 1006, an input unit 1007, and a display unit 1008. These individual configurations are connected through a bus so as to be able to transmit and receive data to and from one another.

The controller 1001 is a CPU that controls each device, performs data operation, and processes data in a computer. In addition, the controller 1001 is an arithmetic device that executes a program stored in the main storage unit 1002 or the auxiliary storage unit 1003, and the controller 1001 receives data from the input unit 1007 or a storage device, and outputs the data to the display unit 1008, a storage device, or the like after performing operation on the data or processing the data.

The main storage unit 1002 is a read only memory (ROM), a random access memory (RAM), or the like, and is a storage device storing or temporarily storing data and a program such as an OS serving as basic software, application software, or the like to be execute by the controller 1001.

The auxiliary storage unit 1003 is a hard disk drive (HDD) or the like, and is a storage device storing therein data relating to the application software or the like.

The drive device 1004 reads out a program from the recording medium 1005, for example, a flexible disk, and installs the program into a storage device.

In addition, a predetermined program is stored in the recording medium 1005, and the program stored in the recording medium 1005 is installed into the mobile terminal device 1000 through the drive device 1004. The installed predetermined program becomes able to be executed by the mobile terminal device 1000.

The network I/F unit 1006 is an interface between the mobile terminal device 1000 and a peripheral device that includes a communication function and is connected through a network such as a local area network (LAN), a wide area network (WAN), or the like, established using data transmission paths such as a wire line and/or a wireless link or the like.

The input unit 1007 includes a keyboard including a cursor key, numeric input, various kinds of function keys, and the like, and a mouse, a touch-pad, or the like, used for selecting a key on the display screen of the display unit 1008. In addition, the input unit 1007 is a user interface used by a user to provide an operating instruction to the controller 1001 or input data.

The display unit 1008 is configured using a cathode ray tube (CRT), a liquid crystal display (LCD), or the like, and performs display in accordance with display data input from the controller 1001.

In this way, the velocity calculation processing described in the above-mentioned embodiments may be realized as a program used for causing a computer to execute the velocity calculation processing. This program is installed from a server or the like, thereby causing the computer to execute the program, and hence it may be possible to realize the above-mentioned velocity calculation processing.

In addition, this program is recorded in the recording medium 1005, the recording medium 1005 in which this program is recorded is caused to be read out by a computer or a mobile terminal, and hence it may also be possible to realize the above-mentioned velocity calculation processing. In addition, various types of recording media may be used as the recording medium 1005. Examples of the recording media include recording media such as a CD-ROM, a flexible disk, a magnetooptical disk, and the like optically, electrically, or magnetically recording information, semiconductor memories such as a ROM, a flash memory, and the like electrically recording information. In addition, the velocity calculation processing described in each of the above-mentioned embodiments may be realized using one integrated circuit or a plurality of integrated circuits.

While the embodiments have been described so far, this technology is not limited to a specific embodiment, and various modifications and various alterations may be made hereto without departing from the spirit and scope of the appended claims. In addition, all configuration elements of each of the above-mentioned embodiments or a plurality of configuration elements thereof may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal device comprising:
an acquisition unit configured to acquire a velocity based on GPS information;
a first calculation unit configured to calculate a correlation coefficient and a correlation value between an acceleration obtained from the velocity and data of an acceleration sensor;
a second calculation unit configured to calculate, using the correlation coefficient, the correlation value, and the data of the acceleration sensor, an acceleration in a section in which it is hard to receive the GPS information; and
a third calculation unit configured to calculate a velocity in the section using the acceleration calculated by the second calculation unit and velocities acquired before and after the section.

2. The device according to claim 1,
wherein the third calculation unit further comprising:
an addition unit configured to add, to the velocity acquired before the section, the acceleration calculated by the second calculation unit, every predetermined time; and
a subtraction unit configured to subtract, from the velocity acquired after the section, the acceleration calculated by the second calculation unit, every predetermined time;
wherein the third calculation unit calculates the velocity in the section using the velocity subjected to addition due to the addition unit and the velocity subjected to subtraction due to the subtraction unit.

3. The device according to claim 1,
wherein the third calculation unit further comprising:
a proportional division unit configured to proportionally divide the velocity subjected to addition due to the addition unit and the velocity subjected to subtraction due to the subtraction unit in accordance with the number of sections of the section and calculate the velocity in the section.

4. The device according to claim 1, further comprising:
an acceleration correction unit configured to correct the acceleration calculated by the second calculation unit so that the acceleration falls within a predetermined range,
wherein the third calculation unit calculates the velocity in the section using the corrected acceleration.

5. The device according to claim 4,
wherein the acceleration correction unit calculates a variation width of an acceleration with respect to kinetic energy of a velocity of the vehicle, and defines the variation width as the predetermined range.

6. The device according to claim 1, further comprising:
an atmospheric pressure sensor; and
a velocity correction unit configured to subtract an amount corresponding to an acceleration having a correlation with data of the atmospheric pressure sensor, from the velocity in the section when there is a correlation between a differential value of the calculated velocity in the section with respect to a temporal axis and a differential value of the data of the atmospheric pressure sensor with respect to a temporal axis.

7. A velocity calculation method comprising;
acquiring a velocity based on GPS information;
calculating a correlation coefficient and a correlation value between an acceleration obtained from the velocity and data of an acceleration sensor;
using the correlation coefficient, the correlation value, and the data of the acceleration sensor, calculating an acceleration, by a processor, in a section in which it is hard to receive the GPS information; and
calculating a velocity in the section using the calculated acceleration and velocities acquired before and after the section.

8. The method according to claim 7,
wherein the calculating the velocity further comprising:
adding, to the velocity acquired before the section, the acceleration calculated by the calculating the acceleration, every predetermined time; and
subtracting, from the velocity acquired after the section, the acceleration calculated by the calculating the acceleration, every predetermined time;
wherein the calculating the velocity calculates the velocity in the section using the velocity subjected to addition due to the adding and the velocity subjected to subtraction due to the subtracting.

9. The method according to claim 7,
wherein the calculating the velocity is proportionally dividing the velocity subjected to addition due to the adding and the velocity subjected to subtraction due to the subtracting in accordance with the number of sections of the section and calculating the velocity in the section.

10. The method according to claim 7, further comprising:
correcting the acceleration calculated by the calculating the acceleration so that the acceleration falls within a predetermined range,
wherein the calculating the velocity is calculating the velocity in the section using the corrected acceleration.

11. The method according to claim 10,
wherein the correcting is calculating a variation width of an acceleration with respect to kinetic energy of a velocity of the vehicle and defining the variation width as the predetermined range.

12. The method according to claim 7, further comprising:
subtracting an amount corresponding to an acceleration having a correlation with data of an atmospheric pressure sensor, from the velocity in the section and correcting a velocity, when there is a correlation between a differential value of the calculated velocity in the section with respect to a temporal axis and a differential value of the data of the atmospheric pressure sensor with respect to a temporal axis.

13. A computer-readable storage medium storing a velocity calculation program causing a computer to execute a process comprising:
acquiring a velocity based on GPS information;
calculating a correlation coefficient and a correlation value between an acceleration obtained from the velocity and data of an acceleration sensor;
using the correlation coefficient, the correlation value, and the data of the acceleration sensor, calculating an acceleration, by a processor, in a section in which it is hard to receive the GPS information; and
calculating a velocity in the section using the calculated acceleration and velocities acquired before and after the section.

14. The computer-readable storage medium according to claim 13,
wherein the calculating the velocity further comprising:
adding, to the velocity acquired before the section, the acceleration calculated by the calculating the acceleration, every predetermined time; and
subtracting, from the velocity acquired after the section, the acceleration calculated by the calculating the acceleration, every predetermined time;
wherein the calculating the velocity calculates the velocity in the section using the velocity subjected to addition due to the adding and the velocity subjected to subtraction due to the subtracting.

15. The computer-readable storage medium according to claim 13,
wherein the calculating the velocity is proportionally dividing the velocity subjected to addition due to the adding and the velocity subjected to subtraction due to the subtracting in accordance with the number of sections of the section and calculating the velocity in the section.

16. The computer-readable storage medium according to claim 13, further comprising:
correcting the acceleration calculated by the calculating the acceleration so that the acceleration falls within a predetermined range,
wherein the calculating the velocity is calculating the velocity in the section using the corrected acceleration.

17. The computer-readable storage medium according to claim 13,
wherein the correcting is calculating a variation width of an acceleration with respect to kinetic energy of a velocity of the vehicle and defining the variation width as the predetermined range.

18. The computer-readable storage medium according to claim 13, further comprising:
subtracting an amount corresponding to an acceleration having a correlation with data of an atmospheric pressure sensor, from the velocity in the section and correcting a velocity, when there is a correlation between a differential value of the calculated velocity in the section with respect to a temporal axis and a differential value of the data of the atmospheric pressure sensor with respect to a temporal axis.
